(19) United States
(12) Patent Application Publication
(10) Pub. No.: US 2018/0071866 A1
(43) Pub. Date: Mar. 15, 2018

(54) METHOD FOR PRODUCING ALUMINUM JOINED BODY

(71) Applicant: Kabushiki Kaisha Kobe Seiko Sho (Kobe Steel, Ltd.), Kobe-shi (JP)

(72) Inventors: Takuro AOKI, Fujisawa-shi (JP); Tsuyoshi MATSUMOTO, Fujisawa-shi (JP); Tomoyuki KITAMURA, Moka-shi (JP)

(73) Assignee: Kabushiki Kaisha Kobe Seiko Sho (Kobe Steel, Ltd.), Kobe-shi (JP)

(21) Appl. No.: 15/674,630

(22) Filed: Aug. 11, 2017

(30) Foreign Application Priority Data
Sep. 14, 2016 (JP) 2016-180001

(51) Int. Cl. B23K 26/22; B23K 26/046; B23K 26/08

(52) U.S. Cl. CPC B23K 26/22; B23K 26/0876; B23K 26/046

(57) ABSTRACT

A method for producing an aluminum joined body includes a step in which a second aluminum member is superimposed on a first aluminum member to form a lap joint, the second aluminum member having a higher electrical conductivity than the first aluminum member; and a beam welding step in which a high-energy beam is impinged on a side of the lap joint on which the second aluminum member is located in order to form a fusion-solidification zone that penetrates the lap joint.

### BACKGROUND OF THE INVENTION

### 1. Field of the Invention

The present invention relates to a method for producing an aluminum joined body.

### 2. Description of the Related Art

Reductions in the weights of automotive components have been essential in order to increase fuel economy. Aluminum and aluminum alloys are suitable for the volume production of automotive components, since they are lightweight, have a high specific strength (i.e., strength per unit weight), and enable the costs for reducing the weights of automotive components to be reduced.

Beam welding, such as laser welding, enables a weld joint having deep penetration to be formed with a small amount of beat input. The use of “remote welding”, in which welding is performed by scanning a laser beam with a mirror, is being widely spread. By remote welding, it is possible to scan a laser beam in various patterns, such as a circular pattern, a spiral pattern, a parallel-line pattern, and zigzag pattern (e.g., see Japanese Unexamined Patent Application Publication No. 2011-173146).

A material having a high thermal expansion coefficient, such as aluminum or an aluminum alloy, is likely to crack because of rapid solidification of a fusion zone. In particular, use of spot welding (i.e., beam spot welding) increases the occurrence of cracking because it causes a fusion zone to be stretched in a circumferential direction. One of the known methods for reducing the occurrence of cracking is to, subsequent to the formation of a spotted fusion-solidification zone, scan a laser beam on a region surrounding the periphery of the fusion-solidification zone in order to reduce the speed at which the fusion zone solidifies (e.g., see Japanese Unexamined Patent Application Publication No. 2015-199097).

Another example of the known methods for reducing the occurrence of cracking is to perform welding with a small beam spot size by irradiating a plurality of irradiation regions with a beam while gradually reducing the amount of heat input at the beam spot in order to reduce the inconsistencies in the size of fusion-solidification zones (e.g., see Japanese Unexamined Patent Application Publication No. 2015-221446).

In beam spot welding, the beam spot size (i.e., the diameter of a fusion-solidification zone in a plan view) is preferably 3 mm or more in order to increase the strength of a weld joint. However, the larger the spot size, the higher the occurrence of cracking. In addition, it is difficult to reduce the occurrence of cracking only by controlling welding conditions, such as a method of scanning a laser beam, because aluminum and aluminum alloys have a high thermal expansion coefficient.

### SUMMARY OF THE INVENTION

Accordingly, it is an object of the present invention to provide a method for producing an aluminum joined body which may reduce the occurrence of cracking in a fusion-solidification zone while maintaining a certain beam spot size required for ensuring a sufficient joint strength.

The present invention provides a method for producing an aluminum joined body, the method including a step in which a second aluminum member is superimposed on a first aluminum member to form a lap joint, the second aluminum member having a higher electrical conductivity than the first aluminum member; and a beam welding step in which a high-energy beam is impinged on a side of the lap joint on which the second aluminum member is located in order to form a fusion-solidification zone that penetrates the lap joint.

### BRIEF DESCRIPTION OF THE DRAWINGS

FIG. 1 is an overall view of a laser welding apparatus used in the method for producing an aluminum joined body according to an embodiment;

FIG. 2 is a cross-sectional view of the aluminum joined body illustrated in FIG. 1, which is taken in a direction in which a beam is impinged;

FIG. 3 is a schematic diagram illustrating a zone irradiated with a defocused beam;

FIG. 4 is a schematic diagram illustrating a zone irradiated with a beam scanned in a concentric pattern;

FIG. 5 is a schematic diagram illustrating a zone irradiated with a beam scanned in a spiral pattern;

FIG. 6 is a schematic diagram illustrating a fusion-solidification zone in which cracking occurred;

FIG. 7 is a cross-sectional view of the aluminum joined body, illustrating the state of a fusion-solidification zone formed when the upper sheet has a higher electrical conductivity;

FIG. 8 is a cross-sectional view of the aluminum joined body, illustrating the state of a fusion-solidification zone formed when the lower sheet has a higher electrical conductivity;

FIG. 9 is a perspective view of a lap joint formed by laser spot welding;

FIG. 10 is a perspective view of a lap joint formed by continuous laser welding;

FIG. 11 is a graph illustrating a change in the length of a crack which occurred when the relative vertical positions of a 6022 sheet and a 3003 sheet were reversed;

FIG. 12 is a graph illustrating a change in the length of a crack which occurred when the relative vertical positions of a 6022 sheet and an Al-1 wt % Fe sheet were reversed;

FIG. 13 is a graph illustrating the lengths of cracks formed in samples that included a 6022 sheet serving as an upper sheet and a clad sheet serving as a lower sheet; and

FIG. 14 is a graph illustrating the lengths of cracks formed in samples that included a clad sheet serving as an upper sheet and a 6022 sheet serving as a lower sheet.

### DESCRIPTION OF THE PREFERRED EMBODIMENTS

An embodiment of the present invention is described below in detail with reference to the attached drawings.

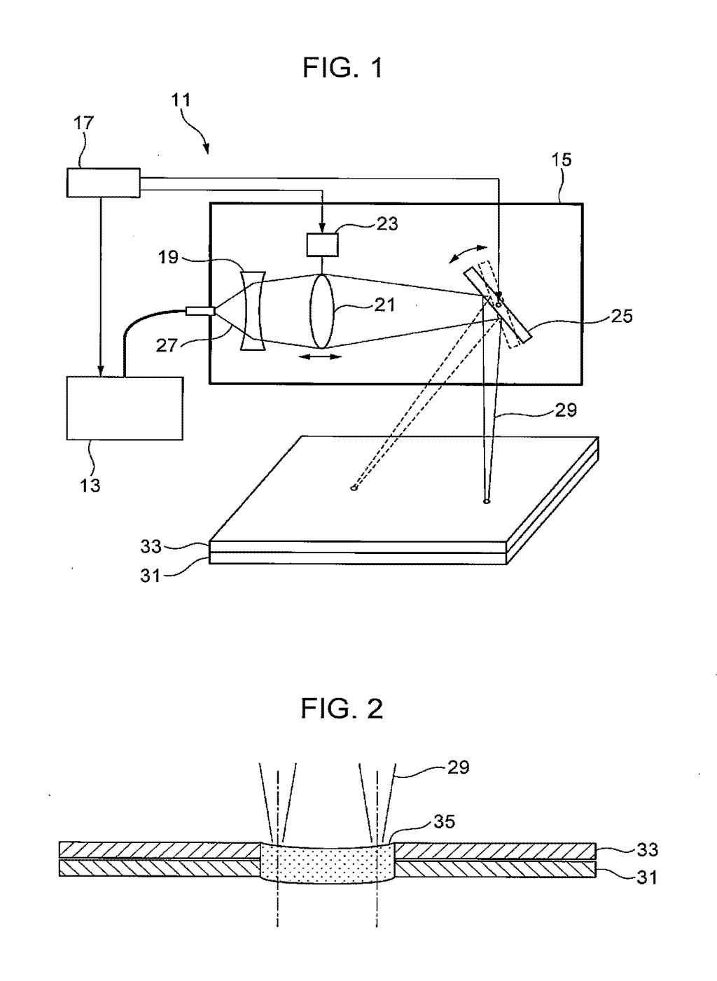

FIG. 1 is an overall view of a laser welding apparatus used in the method for producing an aluminum joined body according to an embodiment.

In the method for producing an aluminum joined body according to the embodiment, a high-energy-beam welding may be employed. Examples of the high-energy-beam welding include laser welding and electron-beam welding.

An example of laser welding is remote welding, in which welding is performed using a light-condensing optical system with a long focal length. Remote welding may be performed by “mirror scanning” in which a laser beam is scanned using a Galvano mirror or by “robot scanning” in which welding is performed using a welding torch having a long focal length which is moved by the action of a robot. The above welding processes are advantageous in that welding can be performed without being limited by the interference between a welding torch and a workpiece, in contrast to ordinary laser welding in which welding is performed in the vicinity of a workpiece. Furthermore, mirror scanning enables rapid multi-spot welding. Robot scanning enables remote welding at a lower cost, although it becomes difficult to markedly reduce the amount of “air cut” time required by multi-spot welding due to the control of the action of the robot.

The welding process used in the method for producing the aluminum joined body according to the embodiment, which is described below, is laser spot welding, in which spot welding is performed with a laser welding apparatus 11 using mirror scanning. Alternatively, an electron-beam welding process, which uses an electron beam instead of a laser beam, may also be employed.

The laser welding apparatus 11, which uses mirror scanning, includes a laser oscillator 13, a laser scanning head 15, and a controller 17 that controls the laser oscillator 13 and the laser scanning head 15. The laser scanning head 15 includes a concave lens 19, a condensing lens 21, an actuator 23, a mirror 25, and the like.

The laser oscillator 13 outputs laser light 27 in accordance with a command sent from the controller 17. The amount of energy of the laser light 27 can be controlled in accordance with the command sent from the controller 17. The laser light 27 output from the laser oscillator 13 is diverged through the concave lens 19 and then condensed through the condensing lens 21. The condensed laser light is reflected by the mirror 25 and then forms a high-energy beam (i.e., a laser beam 29), which is impinged on a portion of a workpiece which is to be welded. For generating the laser beam 29, various types of lasers such as a CO₂ laser, a YAG laser, a fiber laser, a disk laser, and a semiconductor laser, may be used.

The condensing lens 21 is capable of being moved by the actuator 23 in the direction of the optical axis at a high speed. The focal length of the laser light 27 can be adjusted as a result of the movement of the condensing lens 21 in the direction of the optical axis. The focal point of the laser light 27 is a point at which the area of a region irradiated with the laser light 27 (i.e., the beam spot size) is minimized and the energy density of the laser light 27 is maximized. The actuator 23 of the condensing lens 21 is connected to the controller 17, which controls the focal length.

Thus, the laser welding apparatus 11 enables the laser light 27 output through the condensing lens 21 to be readily impinged at a high speed with a desired focal length by tilting the mirror 25 of the laser scanning head 15.

FIG. 2 is a cross-sectional view of the aluminum joined body illustrated in FIG. 1, which is taken in a direction in which a beam is emitted.

The method for producing an aluminum joined body, in which a lap joint is formed using the above-described laser welding apparatus 11, includes a lap joint-forming step and a beam welding step. In the lap joint-forming step, a second aluminum member 33 is superimposed on a first aluminum member 31 to form a lap joint. The second aluminum member 33 has a higher electrical conductivity than the first aluminum member 31. In this embodiment, an electrical conductivity is expressed in the Percent IACS (international annealed copper standard) unit.

According to the Wiedemann-Franz law, in a general relationship between the electrical conductivity of a material and the thermal conductivity of the material, the larger the number of electrons, the higher the electron thermal conductivity, when the material is a metal. The electrical conductivities of metals increase, for example, in the order of aluminum (Al), gold (Au), copper (Cu), and silver (Ag). The thermal conductivities of the above metals increase in the same order as above. In other words, electrical conductivity is proportional to thermal conductivity.

The difference between the electrical conductivity W1 of the first aluminum member 31 and the electrical conductivity W2 of the second aluminum member 33 is preferably, for example, 7 or more.

The first and second aluminum members 31 and 33 may be made of any of the 1000 series aluminum and the 2000 to 8000 series aluminum alloys. The 5000 series aluminum alloys, the 6000 series aluminum alloys, and the 7000 series aluminum alloys are preferable in terms of mechanical strength. The first and second aluminum members 31 and 33 may be constituted by a single layer or may be provided with a clad layer made of aluminum or an Al—Si alloy disposed on the surface of the aluminum member.

In the beam welding step, the laser beam 29 is impinged on a side of the lap joint, which is formed by superimposing the second aluminum member 33 serving as an upper sheet on the first aluminum member 31 serving as a lower sheet, on which the second aluminum member serving as an upper sheet having a higher electrical conductivity is located. The laser beam 29 forms a fusion-solidification zone 35 that penetrates the lap joint. In the method for producing an aluminum joined body, a material having a higher electrical conductivity (i.e., having a higher thermal conductivity) is disposed on the upper side. This reduces tensile stress as described below.

The diameter of the laser beam 29 at a weld zone is 0.3 to 4.0 mm. The diameter of the laser beam can be controlled appropriately by changing the amount of heat input or the method of scanning the beam. In laser spot welding, beam irradiation may be performed in the manner of “keyhole welding”. Alternatively, defocused beam welding, in which the focal point of a beam is deviated in the thickness direction of a workpiece, may also be used. As described below, the beam may be scanned in various patterns, such as a concentric pattern and a spiral pattern.

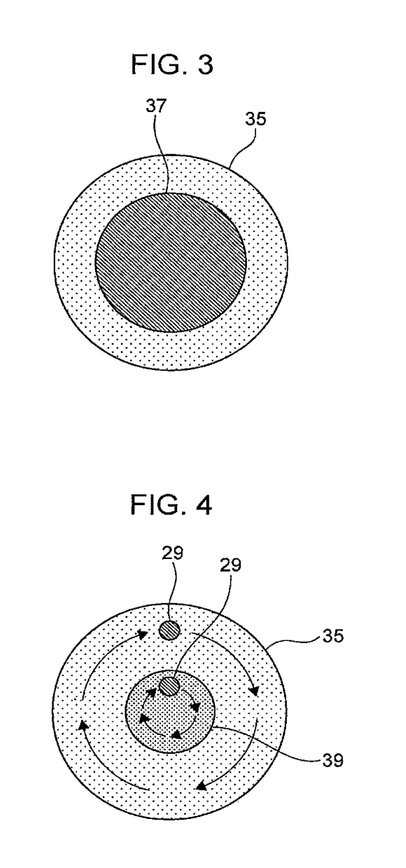

FIG. 3 is a schematic diagram illustrating a zone irradiated with a defocused beam. Laser spot welding may be performed by defocusing a laser beam. A defocused beam 37 can be formed as a result of the condensing lens 21 being moved in a direction of the optical axis by the controller 17 included in the laser welding apparatus 11 illustrated in FIG. 1, that is, for example, by the action of the actuator 23.

FIG. 4 is a schematic diagram illustrating a zone irradiated with a beam scanned in a concentric pattern.

Laser spot welding may be performed by scanning the laser beam 29 plural times in a concentric pattern. In the concentric scanning of the laser beam 29, a zone peripheral to an initial irradiation region 39, which is a region initially irradiated with the laser beam 29, is successively irradiated with the laser beam 29 in a concentric pattern. The concentric scanning of the laser beam 29 can be achieved by the controller 17 included in the laser welding apparatus 11 illustrated in FIG. 1 tilting the mirror 25.

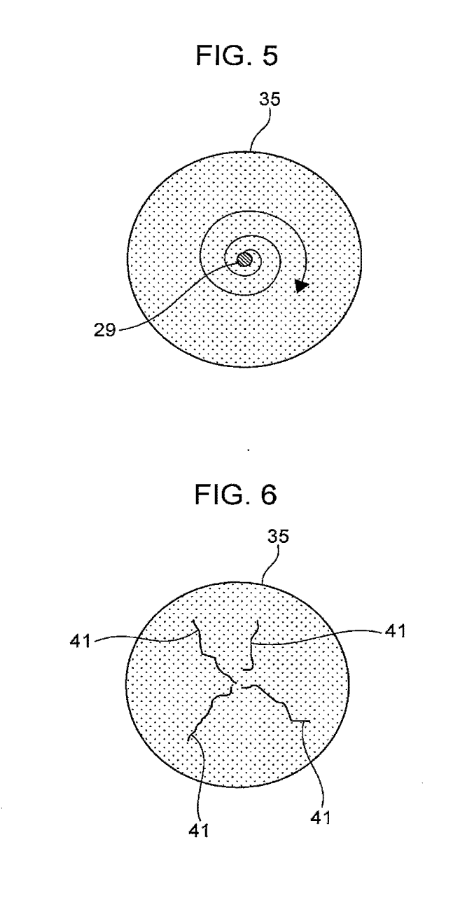

FIG. 5 is a schematic diagram illustrating a zone irradiated with a beam scanned in a spiral pattern.

Laser spot welding may also be performed by scanning the laser beam 29 plural times in a spiral pattern. In the spiral scanning of the laser beam 29, the laser beam 29 is scanned sequentially from the center of a weld zone toward the periphery of the weld zone in a spiral pattern. The spiral scanning of the laser beam 29 can be achieved by tilting the mirror 25 as in the above concentric scanning.

The action of the above-described structure is described below.

FIG. 6 is a schematic diagram illustrating a fusion-solidification zone in which cracking occurred.

The welding heat source used in the method for producing an aluminum joined body is a moving heat source. Accordingly, a weld zone is subjected to a heat cycle. The temperature of a weld zone is rapidly increased as the heat source approaches and, after reaching the maximum temperature, starts decreasing. A crack 41 in the weld zone which may occur in this heat cycle greatly depends on cooling characteristics. The principal items of the cooling characteristics are cooling rate and cooling time. In the present invention, attention is focused also on the electrical conductivity (i.e., thermal conductivity) of a workpiece.

In the method for producing an aluminum joined body, the second aluminum member 33 is superimposed on the first aluminum member 31 to form a lap joint, the second aluminum member 33 having a higher electrical conductivity than the first aluminum member 31. Subsequently, the laser beam 29 is impinged on a side of the lap joint on which the second aluminum member 33 is located in order to form the fusion-solidification zone 35 that penetrates the lap joint. In the above steps, a molten pool is formed so as to extend from the second aluminum member 33 serving as an upper sheet to the first aluminum member 31 serving as a lower sheet. When a weld zone solidifies, the molten pool gradually solidifies from the lower-sheet portion. This reduces the occurrence of solidification cracking.

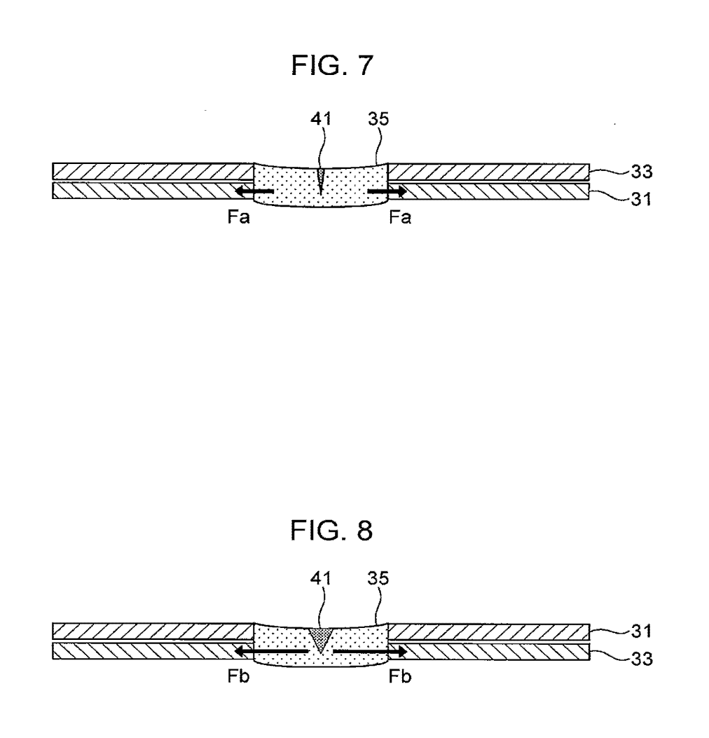

FIG. 7 is a cross-sectional view of the aluminum joined body, illustrating the state of the fusion-solidification zone 35 which occurs when the upper sheet has a higher electrical conductivity. In FIG. 7, Fa represents a tensile stress.

In the case where the upper sheet has a higher electrical conductivity than the lower sheet, a crack or a distortion that occurred in the lower-layer zone, which solidifies slowly, is less likely to propagate into the upper-layer zone. Thus, the crack 41 is small or does not occur.

FIG. 8 is a cross-sectional view of the aluminum joined body, illustrating the state of the, fusion-solidification zone 35 which occurs when the lower sheet has a higher electrical conductivity. In FIG. 8, Fb represents a tensile stress.

In the case where the lower sheet has a higher electrical conductivity than the upper sheet, a crack or a distortion that occurred in the lower-layer zone, which solidifies early, is likely to propagate into the upper-layer zone, which solidifies slowly. Thus, the crack 41 that occurs in the upper-layer zone is larger than the crack illustrated in FIG. 7. The tensile stresses illustrated in FIGS. 7 and 8 have the following relationship: Fa<Fb.

When the fusion-solidification zone 35 is cooled, a tensile stress occurs in the fusion-solidification zone 35 as a result of contraction. Expansion occurs when the temperature is increased as a result of welding of a weld zone, and contraction occurs when cooling is subsequently performed. This causes a large tensile stress to occur in the fusion-solidification zone 35 in the vicinity of the weld zone. In the production method according to the embodiment, the fusion zone gradually solidifies from the lower-sheet zone. This enables the tensile stress to successively dissipate into the fluidized fusion zone and reduces the tensile stress remaining in the fusion-solidification zone.

In the method for producing an aluminum joined body, an initial molten pool is formed at the center of the targeted fusion-solidification zone 35. In laser spot welding, the laser beam 29 may be scanned plural times in a concentric pattern or a spiral pattern with the center being the molten pool. This enables a molten pool having a size necessary for forming the fusion-solidification zone 35 to be formed by expanding the initial molten pool. Furthermore, since the laser beam 29 can be scanned in any direction, it is possible to form a fusion-solidification zone 35 having a shape other than a perfect-circle shape, such as an elliptical shape or an oval shape.

In the method for producing an aluminum joined body, the initial molten pool may be formed at the center of the targeted fusion-solidification zone 35 by defocusing the laser beam 29. Since the defocused beam 37 has a large irradiation area, it is possible to form a molten pool having a size necessary for forming the fusion-solidification zone 35 at once without scanning the laser beam 29. Although the irradiation depth is reduced as a result of a reduction in the energy density of the laser beam 29, it is possible to maintain the amount of molten metal formed when the laser beam is defocused to be equal to the amount of molten metal formed when the defocusing of the laser beam is not performed. The irradiation depth may be controlled appropriately by changing, for example, the amount of beam-irradiation time.

Modification examples of the method for producing an aluminum joined body according to the above-described embodiment are described below.

### MODIFICATION EXAMPLE 1

The first and second aluminum members 31 and 33 are made of heat-treatable aluminum alloys having the same composition but having been subjected to different temper.

Elements dissolved in a heat-treatable aluminum alloy by a solution treatment may precipitate when an aging treatment is performed. The electrical conductivity of the aluminum alloy varies depending on the state of the precipitate.

Thus, sheets made of the same heat-treatable aluminum alloy are each subjected to a heat treatment under different conditions, such as the implementation of the solution treatment, the implementation of the aging treatment, and the heating temperature and the holding time in the solution treatment or the aging treatment, in order to make a difference in electrical conductivity. As a result, even when a lap joint is formed using the same aluminum member, it is possible to produce a lap joint including an aluminum member having a higher electrical conductivity as an upper sheet and an aluminum member having a lower electrical conductivity as a lower sheet by selectively performing the solution treatment and the aging treatment, which may reduce the formation of the crack 41 in the fusion-solidification zone 35.

### MODIFICATION EXAMPLE 2

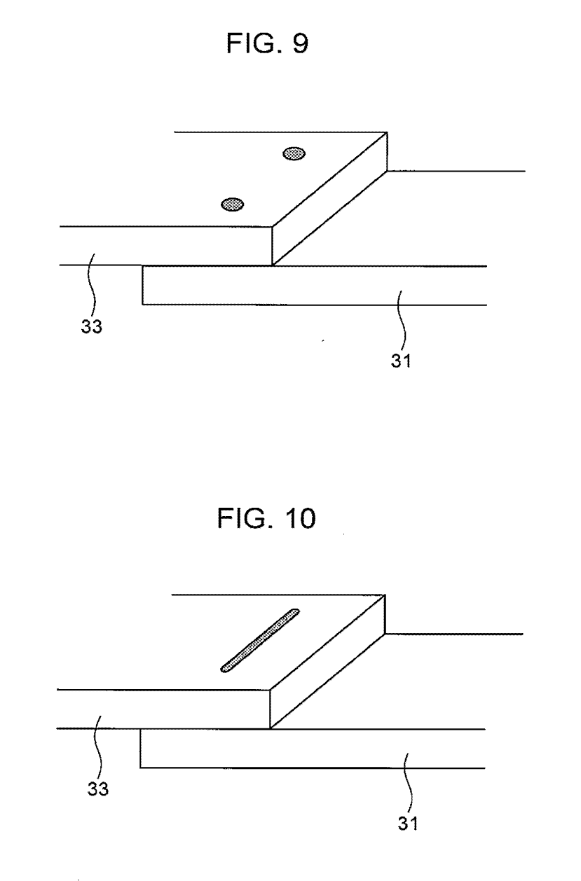

FIG. 9 is a perspective view of a lap joint formed by laser spot welding. FIG. 10 is a perspective view of a lap joint formed by continuous laser welding.

Although the fusion-solidification zone 35 may be formed by laser spot welding as illustrated in FIG. 9, it may alternatively be formed by continuous laser welding using the laser beam 29 as illustrated in FIG. 10.

As described above, the present invention is not limited by the foregoing embodiment. It is assumed in the present invention that the structures according to the embodiment be combined with one another and various modifications and application can be made by those skilled in the art in accordance with the description of the specification and the known technique without departing from the scope of the present invention.

### EXAMPLES

### Example 1

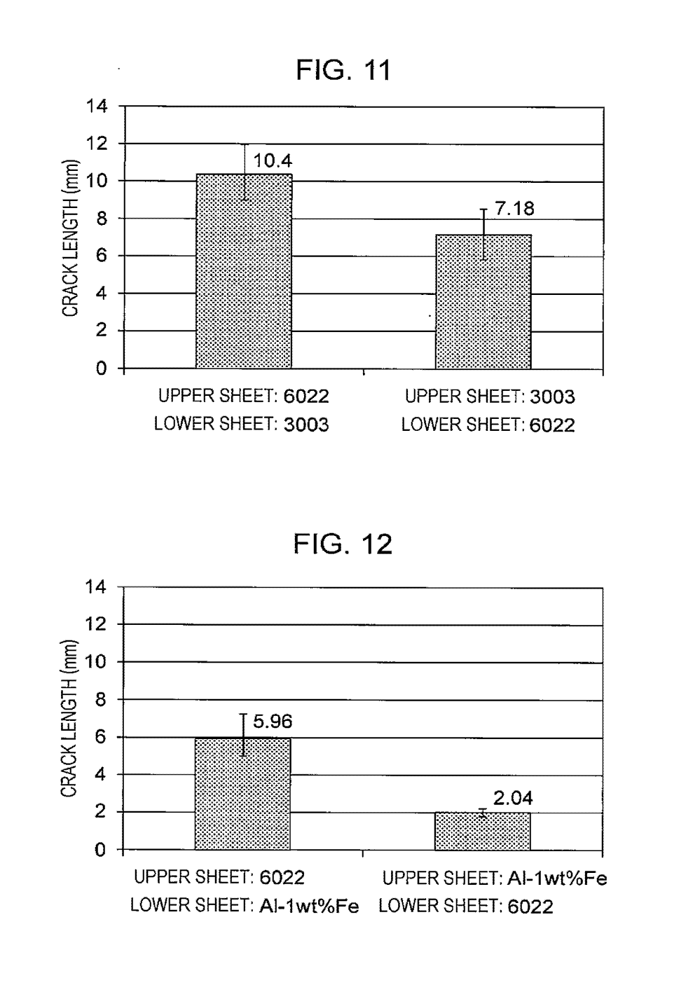

FIG. 11 is a graph illustrating a change in the length of a crack which occurred when the relative vertical positions of a 6022 sheet and a 3003 sheet were reversed. In the bar graphs illustrated in FIGS. 11 to 14, the confidence limits determined from multiple measurements are also shown.

Test Conditions

(a) A 6022-T4 sheet and a 3003-0 sheet having a thickness of 1.0 mm were superimposed on each other and welded.

(b) Laser welding was performed under the following conditions: laser-spot size: 3.5 mm, laser output: 5.5 kW, irradiation time: 1 second.

(c) The laser apparatus used was “YLS-6000-S4” produced by IPG Photonics Corporation.

(d) For measuring electrical conductivity, “SIGMATEST” produced by FOERSTER was used.

(e) The length of a crack formed on the side irradiated with a laser beam was measured with an optical microscope.

The conditions (c) to (e) were applied also to Examples 2 and 3.

Results

FIG. 11 illustrates the length of a crack formed in each of the specimens. A lap joint constituted by a 6022 sheet serving as an upper sheet and a 3003 sheet serving as a lower sheet had a longer crack than a lap joint constituted by a 3003 sheet serving as an upper sheet and a 6022 sheet serving as a lower sheet.

Discussion The reason why the lap joint constituted by a 6022 sheet serving as an upper sheet and a 3003 sheet serving as a lower sheet had a longer crack than the lap joint constituted by a 3003 sheet serving as an upper sheet and a 6022 sheet serving as a lower sheet was considered to be the difference in thermal conductivity between the upper and lower sheets. Since a 6022 sheet has an electrical conductivity of about 45% IACS and a 3003 sheet has an electrical conductivity of about 47% LACS, a 3003 sheet has a higher thermal conductivity than a 6022 sheet. In the case where the lower sheet has a lower heat conductivity than the upper sheet, the width of a molten pool is considered to be smaller at the lower-sheet position than at the upper-sheet position. Consequently, in the lap joint constituted by a 3003 sheet serving as an upper sheet and a 6022 sheet serving as a lower sheet, a fusion zone solidified gradually from the lower-sheet portion. This presumably reduced the occurrence of solidification cracking.

### Example 2

FIG. 12 is a graph illustrating a change in the length of a crack which occurred when the relative vertical positions of a 6022 sheet and an Al-1 wt % Fe sheet were reversed.

Test Conditions

(a) A 6022-T4 sheet and an Al-1 wt % Fe sheet having a thickness of 1.0 mm were superimposed on each other and welded.

(b) Laser irradiation was performed under the following conditions: laser-spot size: 3.5 mm, laser output: 5.5 kW, irradiation time: 1 second.

Results

FIG. 12 illustrates the length of a crack formed in each of the specimens. A lap joint constituted by a 6022 sheet serving as an upper sheet and an Al-1 wt % Fe sheet serving as a lower sheet had a longer crack than a lap joint constituted by an Al-1 wt % Fe sheet serving as an upper sheet and a 6022 sheet serving as a lower sheet.

Discussion The reason why the lap joint constituted by a 6022 sheet serving as an upper sheet and an Al-1 wt % Fe sheet serving as a lower sheet had a longer crack than the lap joint constituted by an Al-1 wt % Fe sheet serving as an upper sheet and a 6022 sheet serving as a lower sheet was considered to be the difference in thermal conductivity between the upper and lower sheets. Since a 6022 sheet has an electrical conductivity of about 45% IACS and an Al-1 wt % Fe sheet has an electrical conductivity of about 58% IACS, an Al-1 wt % Fe sheet has a higher thermal conductivity than a 6022 sheet. In the case where the lower sheet has a lower heat conductivity than the upper sheet, the width of a molten pool is considered to be smaller at the lower-sheet position than at the upper-sheet position. Consequently, in the lap joint constituted by an Al-1 wt % Fe sheet serving as an upper sheet and a 6022 sheet serving as a lower sheet, the fusion zone solidified gradually from the lower-sheet portion. This presumably reduced the occurrence of solidification cracking.

### Example 3

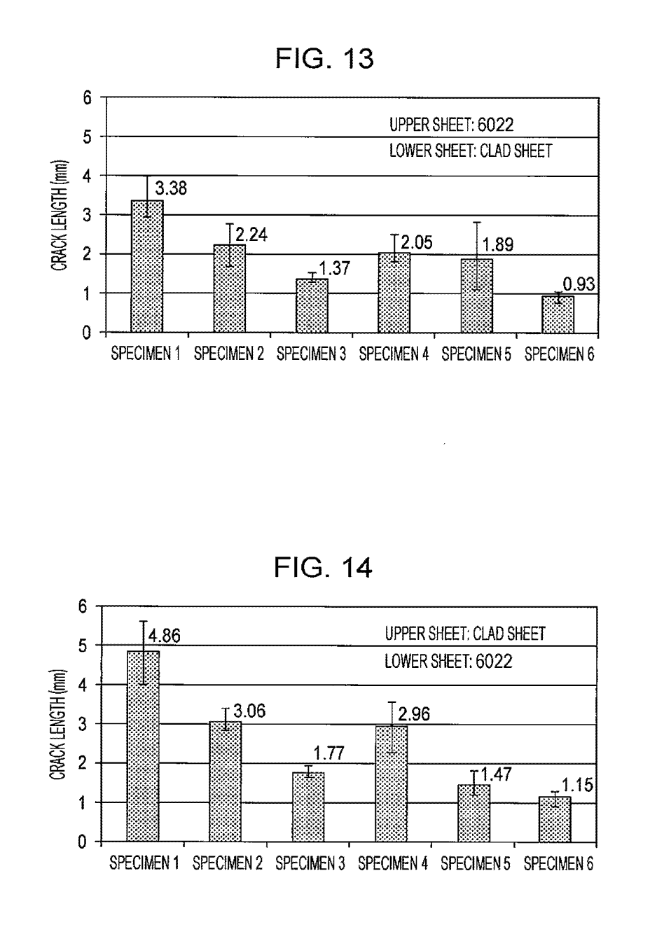

FIG. 13 is a graph illustrating the lengths of cracks formed in samples that included a 6022 sheet serving as an upper sheet and a clad sheet serving as a lower sheet. FIG. 14 is a graph illustrating the lengths of cracks formed in samples that included a clad sheet serving as an upper sheet and a 6022 sheet serving as a lower sheet.

Test Conditions

(a) A 6022-T4 sheet and a specific one of the clad sheets shown in Table 1 having a thickness of 1.0 mm were superimposed on each other and welded. The clad sheets had the core compositions shown in Table 1, and the balance included Fe and inevitable impurities.

(b) Laser irradiation was performed under the following conditions: laser-spot size: 3.5 mm, laser output: 505 kW, irradiation time: 1 second.

TABLE 1

| | Core composition | Skin composition | Clad |
|---|---|---|---|
| No. | (wt %) | (wt %) | ratio (%) |
| Specimen 1 | Al—1.35Si—0.3Mg | Al—12Si | 6 |
| Specimen 2 | | Al—12Si | 10 |
| Specimen 3 | | Al—12Si | 18 |
| Specimen 4 | Al—1.0Si—0.4Mg | Al—12Si | 10 |
| Specimen 5 | | Al—12Si | 18 |
| Specimen 6 | | Al—12Si | 20 |

Results

FIGS. 13 and 14 illustrate the length of a crack formed in each of the specimens. The higher the Si concentration in the skin of the clad sheet, the shorter the crack formed. The lap joints constituted by the clad sheet serving as an upper sheet and a 6022 sheet serving as a lower sheet, which are illustrated in FIG. 14, each had a longer crack than the corresponding one of the lap joints constituted by a 6022 sheet serving as an upper sheet and the clad sheet serving as a lower sheet, which are illustrated in FIG. 13.

Discussion

The reason why the lap joints constituted by the clad sheet serving as an upper sheet and a 6022 sheet serving as a lower sheet each had a longer crack than the corresponding one of the lap joints constituted by a 6022 sheet serving as an upper sheet and the clad sheet serving as a lower sheet was considered to be the difference in thermal conductivity between the upper and lower sheets. Since the clad sheet has an electrical conductivity of 40% to 45% IACS and a 6022 sheet has an electrical conductivity of about 45% IACS, a 6022 sheet has a higher thermal conductivity than the clad sheet. In the case where the lower sheet has a lower heat conductivity than the upper sheet, the width of a molten pool is considered to be smaller at the lower-sheet position than at the upper-sheet position. Consequently, in the lap joint constituted by a 6022 sheet serving as an upper sheet and the clad sheet serving as a lower sheet, the fusion zone solidified gradually from the lower-sheet portion. This presumably reduced the occurrence of solidification cracking.

As described above, the present specification discloses the following.

(1) A method for producing an aluminum joined body, the method including a step in which a second aluminum member is superimposed on a first aluminum member to form a lap joint, the second aluminum member having a higher electrical conductivity than the first aluminum member; and a beam welding step in which a high-energy beam is impinged on a side of the lap joint on which the second aluminum member is located in order to form a fusion-solidification zone that penetrates the lap joint.

In the method for producing an aluminum joined body, a second aluminum member having a higher electrical conductivity than a first aluminum member is superimposed on the first aluminum member to form a lap joint. Subsequently, a high-energy beam is impinged on a side of the lap joint on which the second aluminum member is located in order to form a fusion-solidification zone that penetrates the lap joint. In this method, a molten pool is formed continuously so as to extend from the second aluminum member serving as an upper sheet to the first aluminum member serving as a lower sheet. The width of the molten pool is considered to be smaller in the first aluminum member serving as a lower sheet, which has a lower thermal conductivity, than in the second aluminum member serving as an upper sheet. Consequently, the fusion zone solidifies gradually from the lower-sheet portion. This may reduce the occurrence of solidification cracking.

(2) The method for producing an aluminum joined body described in (1), wherein the fusion-solidification zone is formed by spot welding using the high-energy beam.

In the method for producing an aluminum joined body, a fusion-solidification zone is formed using a high-energy beam. Since the high-energy beam is a concentrated heat source having a high energy density, it reduces the influence of heat on the second aluminum member which occurs during welding and the deformation that may occur in the vicinity of the fusion-solidification zone. This enables the precise formation of a small lap joint.

(3) The method for producing an aluminum joined body described in (2), wherein the spot welding is performed by scanning the high-energy beam plural times in a concentric pattern or a spiral pattern.

In the method for producing an aluminum joined body, an initial molten pool is formed at the center of the targeted fusion-solidification zone. In spot welding, the high-energy beam is scanned plural times in a concentric pattern or a spiral pattern with the center being the molten pool. This enables a molten pool having a size necessary for forming the fusion-solidification zone to be formed by expanding the initial molten pool. Furthermore, since the high-energy beam can be scanned in any direction, it is possible to form a fusion-solidification zone having a shape other than a perfect-circle shape, such as an elliptical shape or an oval shape.

(4) The method for producing an aluminum joined body described in (2), wherein the spot welding is performed by defocusing the high-energy beam.

In the method for producing an aluminum joined body, an initial molten pool is formed at the center of the targeted fusion-solidification zone by defocusing the high-energy beam. Since the defocused high-energy beam has a variable irradiation area, it is possible to form a molten pool having a size necessary for forming the fusion-solidification zone at once without scanning the high-energy beam.

(5) The method for producing an aluminum joined body described in (1), wherein the fusion-solidification zone is formed by continuous welding using the high-energy beam.

In the method for producing an aluminum joined body, the high-energy beam impinged on the second aluminum member is continuously scanned in a linear pattern. This enables the formation of a continuous fusion-solidification zone free from cracking.

What is claimed is:

1. A method for producing an aluminum joined body, the method comprising:
a step in which a second aluminum member is superimposed on a first aluminum member to form a lap joint, the second aluminum member having a higher electrical conductivity than the first aluminum member; and
a beam welding step in which a high-energy beam is impinged on a side of the lap joint on which the second aluminum member is located in order to form a fusion-solidification zone that penetrates the lap joint.

2. The method for producing an aluminum joined body according to claim 1,
wherein the fusion-solidification zone is formed by spot welding using the high-energy beam.

3. The method for producing an aluminum joined body according to claim 2,
wherein the spot welding is performed by scanning the high-energy beam plural times in a concentric pattern or a spiral pattern.

4. The method for producing an aluminum joined body according to claim 2,
wherein the spot welding is performed by defocusing the high-energy beam.

5. The method for producing an aluminum joined body according to claim 1, p1 wherein the fusion-solidification zone is formed by continuous welding using the high-energy beam.
